(19) United States
(12) Patent Application Publication
(10) Pub. No.: US 2021/0157764 A1
(43) Pub. Date: May 27, 2021

(54) DATA CONVERSION DEVICE AND DATA CONVERSION SYSTEM

(71) Applicant: Cheng Uei Precision Industry Co., Ltd., New Taipei City (TW)

(72) Inventors: Chin Huang Tseng, New Taipei City (TW); Chia Kun Lai, New Taipei City (TW)

(21) Appl. No.: 17/067,859

(22) Filed: Oct. 12, 2020

Related U.S. Application Data
(60) Provisional application No. 62/940,124, filed on Nov. 25, 2019.

(51) Int. Cl. G06F 13/42

(52) U.S. Cl. CPC G06F 13/4282; G06F 2213/0002; G06F 2213/0042

(57) ABSTRACT

A data conversion device connected between a host terminal, and an equipment terminal applying an RS-232 (Recommended Standard-232) data format. The equipment terminal has an RS-232 connection port. The host terminal applies a USB (Universal Serial Bus) data format. The host terminal includes a USB docking port. The data conversion device includes a USB connection port connected to the USB docking port, a RS-232 docking port connected with the RS-232 connection port, and a micro controller. The micro controller is connected with the USB connection port and the RS-232 docking port. The micro controller has a group of RS-232 format parameters. The group of the RS-232 format parameters include a communication rate, a parity check and a data bit length. Modify the group of the RS-232 format parameters to make each RS-232 format parameter corresponding to a preset RS-232 data format.

### CROSS-REFERENCE TO RELATED APPLICATION

This application claims the priorities of US provisional patent application No. 62/940,124, filed on Nov. 25, 2019, which is incorporated herewith by reference.

### BACKGROUND OF THE INVENTION

### 1. Field of the Invention

The present invention generally relates to a data conversion device, and more particularly to a data conversion device capable of converting different data formats between two different devices, and a data conversion system including the data conversion device.

### 2. The Related Art

Due to the gradual diversification of technology products with the development of science and technology, a newer type host and an older type RS-232 (Recommended Standard-232) equipment often need to be connected through interconnections among the host and the RS-232 equipment to achieve more functions to be performed.

However, due to different parameter settings existed among different hosts and different RS-232 equipments, such as a communication rate setting, a parity setting, a data bit length setting and other settings, so that the different hosts and the different RS-232 equipments hardly have the same parameter settings to make the different hosts and the different RS-232 equipments hardly proceed with data transmissions.

Therefore, it is necessary to provide an innovative data conversion device and a data conversion system, the data conversion system includes the data conversion device, a host terminal and an equipment terminal, so that the host terminal may be communicated with the equipment terminal having different parameter settings to proceed with a data conversion.

### SUMMARY OF THE INVENTION

An object of the present invention is to provide a data conversion device connected between a host terminal and an equipment terminal. The equipment terminal applies an RS-232 (Recommended Standard-232) data format. The equipment terminal has an RS-232 connection port. The host terminal applies a USB (Universal Serial Bus) data format. The host terminal includes a USB docking port. The data conversion device includes a USB connection port connected to the USB docking port of the host terminal, a RS-232 docking port connected with the RS-232 connection port of the equipment terminal, and a micro controller. The micro controller is connected with the USB connection port and the RS-232 docking port. The micro controller has a group of RS-232 format parameters. The group of the RS-232 format parameters include a communication rate, a parity check and a data bit length. Modify the group of the RS-232 format parameters to make each RS-232 format parameter corresponding to a preset RS-232 data format of the equipment terminal. The micro controller receives USB format data from the host terminal by means of the USB connection port and the USB docking port. The micro controller converts the USB format data into RS-232 format data according to the group of the modified RS-232 format parameters. The micro controller transmits the converted RS-232 format data to the equipment terminal by virtue of the RS-232 connection port and the RS-232 docking port.

Another object of the present invention is to provide a data conversion device connected between a host terminal and an equipment terminal. The equipment terminal applies an RS-232 (Recommended Standard-232) data format. The equipment terminal has an RS-232 connection port. The host terminal applies a USB (Universal Serial Bus) data format. The host terminal includes a USB docking port. The data conversion device includes a USB connection port connected to the USB docking port of the host terminal, a RS-232 docking port connected with the RS-232 connection port of the equipment terminal, and a micro controller. The micro controller is connected with the USB connection port and the RS-232 docking port. The micro controller has a group of RS-232 format parameters. The group of the RS-232 format parameters include a communication rate, a parity check and a data bit length. Modify the group of the RS-232 format parameters to make each RS-232 format parameter corresponding to a preset RS-232 data format of the equipment terminal. The micro controller receives RS-232 format data from the equipment terminal according to the group of the modified RS-232 format parameters and by means of the RS-232 connection port and the RS-232 docking port. The micro controller converts the RS-232 format data into USB format data. The micro controller transmits the converted USB format data to the host terminal by virtue of the USB connection port and the USB docking port.

Another object of the present invention is to provide a data conversion system. The data conversion system includes a host terminal applying a USB (Universal Serial Bus) data format, an equipment terminal applying an RS-232 (Recommended Standard-232) data format, and a data conversion device connected between the host terminal and the equipment terminal. The host terminal includes a USB docking port. The equipment terminal has an RS-232 connection port. The data conversion device includes a USB connection port connected to the USB docking port of the host terminal, a RS-232 docking port connected with the RS-232 connection port of the equipment terminal, and a micro controller used to proceed with a data format conversion between the USB data format of the host terminal and the RS-232 data format of the equipment terminal. The micro controller is connected with the USB connection port and the RS-232 docking port. The micro controller has a group of RS-232 format parameters. The group of the RS-232 format parameters include a communication rate, a parity check and a data bit length. Modify the group of the RS-232 format parameters to make each RS-232 format parameter corresponding to a preset RS-232 data format of the equipment terminal. The micro controller receives USB format data from the host terminal by means of the USB connection port and the USB docking port, the micro controller converts the USB format data into RS-232 format data according to the group of the modified RS-232 format parameters. The micro controller transmits the converted RS-232 format data to the equipment terminal by virtue of the RS-232 connection port and the RS-232 docking port. The micro controller receives the RS-232 format data from the equipment terminal according to the group of the modified RS-232 format parameters and by means of the RS-232 connection port and the RS-232 docking port, the micro controller converts the RS-232 format data into the USB format data, the micro controller transmits the converted USB format data to the host terminal by virtue of the USB connection port and the USB docking port.

As described above, the data conversion device is connected between the host terminal and the equipment terminal, and the data conversion device may convert the USB format data of the host terminal to the RS-232 format data of the equipment terminal.

### BRIEF DESCRIPTION OF THE DRAWINGS

The present invention will be apparent to those skilled in the art by reading the following description, with reference to the attached drawings, in which:

FIG. 1 is a system block diagram of a data conversion system in accordance with the present invention, wherein a data conversion device is applied to the data conversion system;

FIG. 2 is a data conversion flow chart showing that data is transmitted among the data conversion device, an equipment terminal and a host terminal of the data conversion system;

FIG. 3 is a data conversion flow chart showing that the data is transmitted from the host terminal to the equipment terminal of the data conversion system; and

FIG. 4 is a data conversion flow chart showing that the data is transmitted from the equipment terminal to the host terminal of the data conversion system.

### DETAILED DESCRIPTION OF THE PREFERRED EMBODIMENT

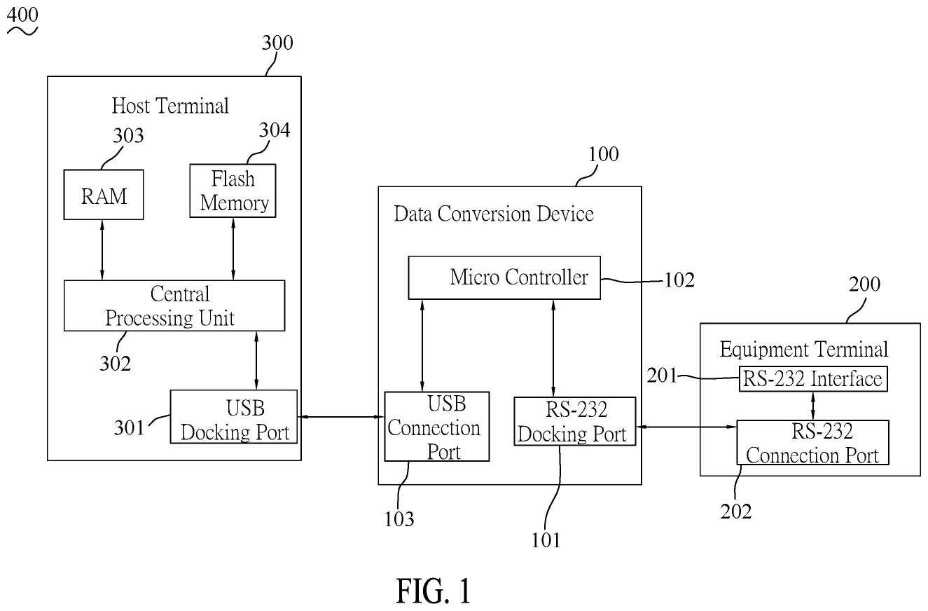

With reference to FIG. 1, a data conversion device 100 and a data conversion system 400 in accordance with the present invention are shown. The data conversion device 100 is a converting and connecting terminal. The data conversion system 400 includes the data conversion device 100, a host terminal 300 and an equipment terminal 200. The data conversion device 100 is connected and used between the host terminal 300 and the equipment terminal 200.

The equipment terminal 200 applies an RS-232 (Recommended Standard-232) data format. The equipment terminal 200 has an RS-232 interface 201, and an RS-232 connection port 202 connected with the RS-232 interface 201. The RS-232 is an interface standard of a serial data communication established by American Electronics Industry Association (EIA). A full name of an original number of the RS-232 is EIA-RS-232, and the RS-232 is short for the EIA-RS-232. The data conversion device 100 includes an RS-232 docking port 101, a micro controller 102 (Micro Control Unit, MCU) and a USB (Universal Serial Bus) connection port 103. The micro controller 102 has a group of RS-232 format parameters. The group of the RS-232 format parameters include a communication rate, a parity check and a data bit length. The host terminal 300 applies a USB data format. The host terminal 300 includes a USB docking port 301, a central processing unit (CPU) 302, a random access memory (RAM) 303 and a flash memory 304. The RS-232 docking port 101 is connected with the micro controller 102 and the RS-232 connection port 202 of the equipment terminal 200.

Modify the group of the RS-232 format parameters to make each RS-232 format parameter corresponding to a preset RS-232 data format of the equipment terminal 200, the micro controller 102 receives USB format data from the host terminal 300 by means of the USB connection port 103 and the USB docking port 301, the micro controller 102 converts the USB format data into RS-232 format data according to the modified RS-232 format parameters, the micro controller 102 transmits the converted RS-232 format data to the equipment terminal 200 by virtue of the RS-232 connection port 202 and the RS-232 docking port 101.

The host terminal 300 carries a USB-HID (Human Interface Device) protocol data format. The data conversion device 100 is a data conversion mechanism that converts data between RS-232 protocol data and USB-HID protocol data. The micro controller 102 of the data conversion device 100 is used to proceed with a data format conversion between the USB data format of the host terminal 300 and an RS-232 data format of the equipment terminal 200. The central processing unit (CPU) 302 of the host terminal 300 is one of main devices of a computer. A main function of the central processing unit (CPU) 302 is to interpret computer instructions and process the data in a software of the computer. The random access memory (RAM) 303 is a memory that directly exchanges the data with the CPU 302. The random access memory (RAM) 303 reads and writes at any time, and a speed of the random access memory (RAM) 303 is quite fast. The random access memory (RAM) 303 is usually used as a temporary data storage medium of an operation system or other running programs. The flash memory 304 is an electronically erasable, programmable and read-only memory form, and the flash memory 304 is a memory which allows to be erased or written repeatedly during an operation of the flash memory 304. This technology of the host terminal 300 is mainly used for general data storages, and exchanging transmission data between computers and other digital products, such as memory cards and flash disks.

The RS-232 connection port 202 of the equipment terminal 200 is connected with the RS-232 docking port 101 of the data conversion device 100, and the USB connection port 103 of the data conversion device 100 is connected with the micro controller 102 and is connected to the USB docking port 301 of the host terminal 300. The data conversion device 100 is a two-way conversion platform to proceed with a two-way data conversion application of the data from the equipment terminal 200 or the host terminal 300.

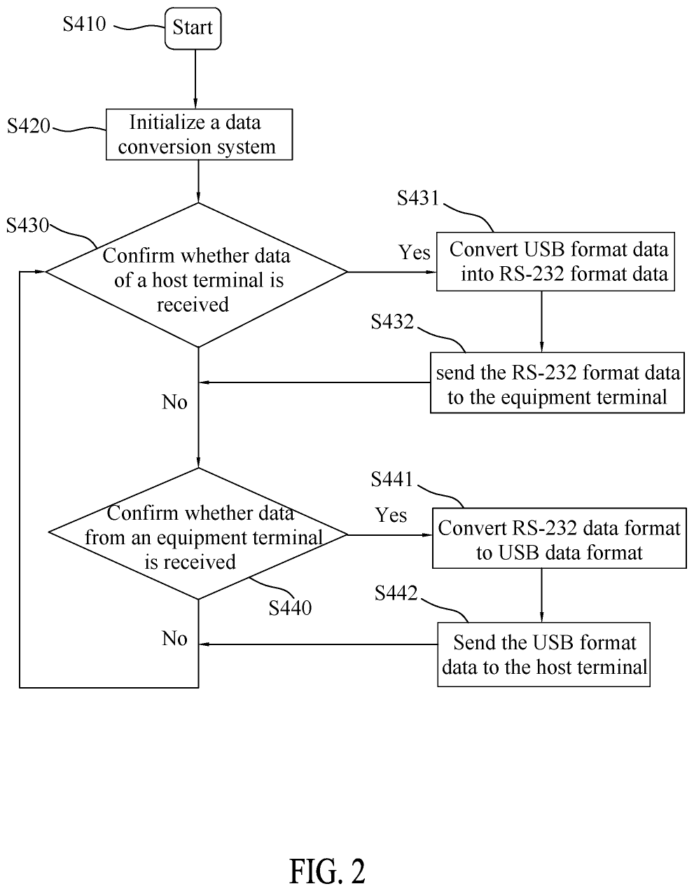

With reference to FIG. 1 and FIG. 2, when the data is transmitted between the equipment terminal 200 and the host terminal 300 by the data conversion device 100, the data will be converted under a plurality of operations, and specific data conversion steps of the plurality of the operations are described as follows. The specific data conversion steps are proceeded in the micro controller 102 of the data conversion device 100.

Step S410: start the micro controller 102.

Step S420: initialize the data conversion system 400. Specifically, initialize the USB connection port 103 of the data conversion device 100 to make the USB connection port 103 support a USB-HID format, and initialize the RS-232 docking port 101 of the data conversion device 100 to make the RS-232 docking port 101 support a RS-232 format, so that the micro controller 102 supports both the USB-HID format and the RS-232 format.

Step S430: confirm whether the data of the host terminal 300 is received. If the micro controller 102 is without receiving the data from the host terminal 300, proceed with a next step S440. If the micro controller 102 receives the data from the host terminal 300, proceed a step S431.

Step S440: confirm whether the data from the equipment terminal 200 is received, if the micro controller 102 is without receiving the data from the equipment terminal 200, return to the step S430, if the micro controller 102 receives the data from the equipment terminal 200, proceed with a step S441 of an operation of converting the data of the equipment terminal 200 from the RS-232 data format into the USB data format of the host terminal 300.

When step S430 is performed, if the micro controller 102 receives the data from the host terminal 300, proceed with the step S431.

Step S431: convert the USB format data from the host terminal 300 into the RS-232 format data, and then proceed with a step S432.

Step S432: send the converted RS-232 format data to the equipment terminal 200, and then return to the step S440.

When the step S440 is performed, if the micro controller 102 receives the data from the equipment terminal 200, proceed with the step S441 of the operation of converting the data of the equipment terminal 200 from the RS-232 data format into the USB data format of the host terminal 300.

Step S441: convert the data of the equipment terminal 200 from the RS-232 data format into the USB data format of the host terminal 300, and then proceed with a step S442.

Step S442: send the USB format data to the host terminal 300, and then return to the step S430.

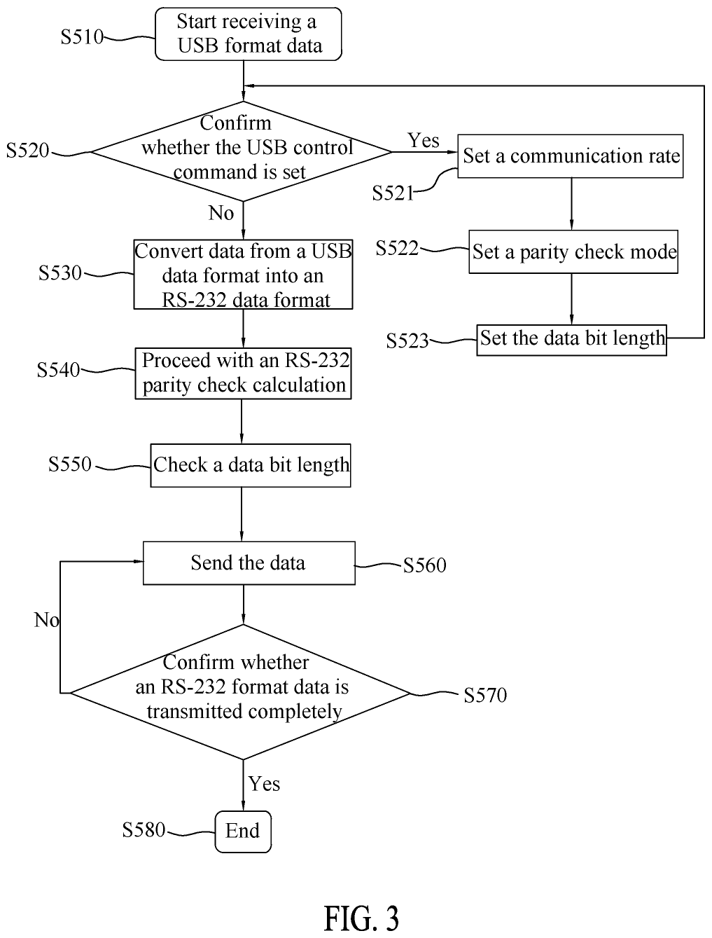

With reference to FIG. 1 and FIG. 3, specifically, in performing the step S431 of one operation of converting the data from the host terminal 300 into the RS-232 data format, proceed with the following data conversion steps of the plurality of the operations in further.

Step S510: start receiving the USB format data. Specifically, enter a judgment formula for judging whether the host terminal 300 transmits the data into the micro controller 102, when the data from the host terminal 300 enters the micro controller 102, proceed with a step S520 of confirming whether a USB control command is set.

Step S520: confirm whether the USB control command is set, if the USB control command is unnecessary to be set, proceed with a step S530 of converting the data from the USB data format into the RS-232 data format. Step S520 is to check relevant RS-232 format parameter settings of the equipment terminal 200. If the related RS-232 format parameter settings of the equipment terminal 200 are the same as preset values of the data conversion device 100, proceed with the step S530 of converting the data from the USB data format into the RS-232 data format.

Step S530: convert the data from the USB data format into the RS-232 data format. Specifically, sixty-four bytes of the USB-HID protocol data is sequentially taken out by way of regarding one byte to be a unit so as to convert the data from the USB-HID format into the RS-232 format.

Step S540: proceed with an RS-232 parity check calculation. Specifically, the step S540 of the operation of proceeding with the RS-232 parity check calculation is to perform an odd parity check calculation or an even parity check calculation, or a non-parity check calculation according to the RS-232 parity check setting set by the equipment terminal 200, and then proceed with a step S550 of an operation of checking the data bit length.#

Step S550: check the data bit length. Specifically, the step S550 is corresponding to an RS-232 data bit length set by the equipment terminal 200, and check whether a length of a converted data packet in the micro controller 102 is the same as the RS-232 data bit length set by the equipment terminal 200. Because a control command has no need of being set in step S520 of the operation of confirming whether the USB control command is set, the length of the converted data packet must be the same as the RS-232 data bit length set by the equipment terminal 200, and then proceed with a step S560 of an operation of sending the data.#

Step S560: send the data. Specifically, the step of the operation of sending the data is to send the converted RS-232 format data to the equipment terminal 200.

Step S570: confirm whether the RS-232 format data is transmitted completely. Specifically, the step S570 of an operation of confirming whether the RS-232 format data is transmitted completely is to confirm whether the RS-232 format data is completed, and confirm whether an end code is transmitted. If the end code is without being transmitted, return to the step S560 to continue transmitting the RS-232 format data, if the end code is transmitted, proceed with a step 5580.#

Step S580: end. Specifically, proceed with the step S432 after the end.

The micro controller 102 converts the USB format data into the RS-232 format data by means of following operations, an operation of the parity check is performed according to the group of the modified RS-232 format parameters, perform an odd parity check calculation, an even parity check calculation or a non-parity check calculation according to the converted RS-232 format data, confirm whether a data bit length of the converted data in the micro controller 102 is the same as the data bit length of one of the group of the modified RS-232 format parameters set by the equipment terminal 200, send the converted RS-232 format data to the equipment terminal 200, confirm whether the converted RS-232 format data is completely transmitted, and confirm whether an end code is transmitted, if the converted RS-232 format data is without being completely transmitted, continue sending the converted RS-232 format data.

If the host terminal 300 transmits the data to the equipment terminal 200 through the data conversion device 100, the equipment terminal 200 has no need of reading the data of the host terminal 300, the parameter setting of the data conversion device 100 are unsynchronized, so that the USB format data of the host terminal 300 has no way of being correctly converted into the RS-232 format data of the equipment terminal 200 by the data conversion device 100. At the moment, check the relevant RS-232 format parameter settings of the data conversion device 100, such as the communication rate setting, the parity check setting, the data bit length setting and other settings, and the relevant RS-232 format parameter settings are set in the data conversion device 100 according to settings of the equipment terminal 200. The relevant RS-232 format parameter settings are also stored in the micro controller 102. In a concrete implementation, the relevant RS-232 format parameter settings are also able to be stored in other components of the data conversion device 100. For example, the relevant RS-232 format parameter settings are stored in a storing unit of the data conversion device 100. The RS-232 format parameter settings of the data conversion device 100 proceed with following steps of following operations.

Step S521: set the communication rate.

Step S522: set the parity check mode. Specifically, the step S522 is the parity check setting contrasting with the RS-232 format, and the parity check setting is set as an RS-232 odd parity check, an RS-232 even parity check, or an RS-232 non-parity check setting.

Step S523: set the data bit length. Because the micro controller 102 will perform the RS-232 format data conversion according to the relevant RS-232 format parameter settings of the data conversion device 100, when the relevant RS-232 format parameter settings of the data conversion device 100 are completed according to the relevant RS-232 format parameter settings of the equipment terminal 200, return to the step S520 of an operation of confirming whether the USB control command is set to proceed with subsequent procedures.

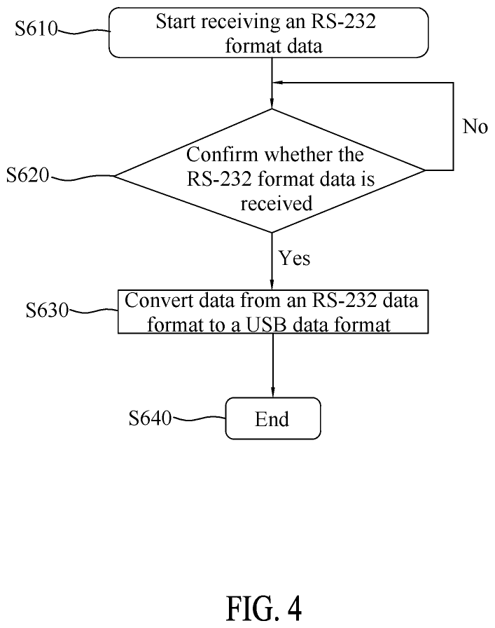

With reference to FIG. 1 and FIG. 4, in the step S441 of the operation of converting the data of the equipment terminal 200 from the RS-232 data format into the USB data format of the host terminal 300, when the micro controller 102 receives the data from the equipment terminal 200, following conversion steps of the operations of the data conversion device 100 will be performed.

Step S610: start receiving the RS-232 format data. Specifically, the step S610 of an operation of starting receiving the RS-232 format data is to enter another judgment formula which is used to judge whether the equipment terminal 200 transmits the data into the micro controller 102. When the data from the equipment terminal 200 enters the micro controller 102, proceed with a step S620 of an operation of confirming whether the RS-232 format data is received.

Step S620: confirm whether the RS-232 format data is received, if the RS-232 format data is received, proceed with a step S630 of an operation of converting the data from the RS-232 data format to the USB data format, if the RS-232 format data is without being received, repeat proceeding with the step S620 of an operation of confirming whether the RS-232 format data is received.

Step S630: convert the data from the RS-232 data format to the USB data format.

Step S640: End. Specifically, proceed with the step S442 of an operation of sending the USB format data to the host terminal 300 after the step S640 is completed.

The micro controller 102 receives the RS-232 format data from the equipment terminal 200 according to the group of the modified RS-232 format parameters and by means of the RS-232 connection port 202 and the RS-232 docking port 101, the micro controller 102 converts the RS-232 format data into the USB format data, the micro controller 102 transmits the converted USB format data to the host terminal 300 by virtue of the USB connection port 103 and the USB docking port 301.

When the step S620 of the operation of confirming whether the RS-232 format data is received is performed, if the RS-232 format data is without being received, continue with the step S620 of the operation of confirming whether the RS-232 format data is received to receive the RS-232 format data again.

Because the host terminal 300 carries the USB format data, the USB format data is usually a parameter setting provided by the data conversion device 100 to the host terminal 300 after the data conversion device 100 is announced. Therefore, related control commands of the USB format data in the host terminal 300 are needless to additionally judged to need to be set or have no need of being set.

As described above, the data conversion device 100 is connected between the host terminal 300 and the equipment terminal 200, and the data conversion device 100 may convert the USB format data of the host terminal 300 to the RS-232 format data of the equipment terminal 200.

What is claimed is:

1. A data conversion device connected between a host terminal and an equipment terminal, the equipment terminal applying an RS-232 (Recommended Standard-232) data format, the equipment terminal having an RS-232 connection port, the host terminal applying a USB (Universal Serial Bus) data format, the host terminal including a USB docking port, the data conversion device comprising:
a USB connection port connected to the USB docking port of the host terminal;
a RS-232 docking port connected with the RS-232 connection port of the equipment terminal; and
a micro controller connected with the USB connection port and the RS-232 docking port, the micro controller having a group of RS-232 format parameters, the group of the RS-232 format parameters including a communication rate, a parity check and a data bit length, modifying the group of the RS-232 format parameters to make each RS-232 format parameter corresponding to a preset RS-232 data format of the equipment terminal, the micro controller receiving USB format data from the host terminal by means of the USB connection port and the USB docking port, the micro controller converting the USB format data into RS-232 format data according to the group of the modified RS-232 format parameters, the micro controller transmitting the converted RS-232 format data to the equipment terminal by virtue of the RS-232 connection port and the RS-232 docking port.

2. The data conversion device as claimed in claim 1, wherein the micro controller converts the USB format data into the RS-232 format data by means of following operations, an operation of the parity check is performed according to the group of the modified RS-232 format parameters, perform an odd parity check calculation, an even parity check calculation or a non-parity check calculation according to the converted RS-232 format data, confirm whether a data bit length of the converted data in the micro controller is the same as the data bit length of one of the group of the modified RS-232 format parameters set by the equipment terminal, send the converted RS-232 format data to the equipment terminal, confirm whether the converted RS-232 format data is completely transmitted, and confirm whether an end code is transmitted, if the converted RS-232 format data is without being completely transmitted, continue sending the converted RS-232 format data.

3. The data conversion device as claimed in claim 2, wherein the micro controller confirms whether the converted RS-232 format data has been completely transmitted to check whether the end code is transmitted.

4. A data conversion device connected between a host terminal and an equipment terminal, the equipment terminal applying an RS-232 (Recommended Standard-232) data format, the equipment terminal having an RS-232 connection port, the host terminal applying a USB (Universal Serial Bus) data format, the host terminal including a USB docking port, the data conversion device comprising:
a USB connection port connected to the USB docking port of the host terminal;
a RS-232 docking port connected with the RS-232 connection port of the equipment terminal; and
a micro controller connected with the USB connection port and the RS-232 docking port, the micro controller having a group of RS-232 format parameters, the group of the RS-232 format parameters including a communication rate, a parity check and a data bit length, modifying the group of the RS-232 format parameters to make each RS-232 format parameter corresponding to a preset RS-232 data format of the equipment terminal, the micro controller receiving RS-232 format data from the equipment terminal according to the group of the modified RS-232 format parameters and by means of the RS-232 connection port and the RS-232 docking port, the micro controller converting the RS-232 format data into USB format data, the micro controller transmitting the converted USB format data to the host terminal by virtue of the USB connection port and the USB docking port.

5. A data conversion system, comprising:
a host terminal applying a USB (Universal Serial Bus) data format, the host terminal including a USB docking port;
an equipment terminal applying an RS-232 (Recommended Standard-232) data format, the equipment terminal having an RS-232 connection port; and
a data conversion device connected between the host terminal and the equipment terminal, including,
a USB connection port connected to the USB docking port of the host terminal,
a RS-232 docking port connected with the RS-232 connection port of the equipment terminal, and
a micro controller used to proceed with a data format conversion between the USB data format of the host terminal and the RS-232 data format of the equipment terminal, the micro controller being connected with the USB connection port and the RS-232 docking port, the micro controller having a group of RS-232 format parameters, the group of the RS-232 format parameters including a communication rate, a parity check and a data bit length, modifying the group of the RS-232 format parameters to make each RS-232 format parameter corresponding to a preset RS-232 data format of the equipment terminal,
wherein the micro controller receives USB format data from the host terminal by means of the USB connection port and the USB docking port, the micro controller converts the USB format data into RS-232 format data according to the group of the modified RS-232 format parameters, the micro controller transmits the converted RS-232 format data to the equipment terminal by virtue of the RS-232 connection port and the RS-232 docking port, and
wherein the micro controller receives the RS-232 format data from the equipment terminal according to the group of the modified RS-232 format parameters and by means of the RS-232 connection port and the RS-232 docking port, the micro controller converts the RS-232 format data into the USB format data, the micro controller transmits the converted USB format data to the host terminal by virtue of the USB connection port and the USB docking port.
